(19) United States
(12) Patent Application Publication
(10) Pub. No.: US 2008/0120428 A1
(43) Pub. Date: May 22, 2008

(54) UNIQUE COMPRESSED CALL IDENTIFIERS

(75) Inventors: Sohel Khan, Lawrence, KS (US); Mark Evans, San Mateo, CA (US); Jeremy Breau, Kansas City, MO (US); Ramaswami Rangarajan, Belmont, CA (US)

Correspondence Address: SPRINT COMMUNICATIONS COMPANY L.P., 6391 SPRINT PARKWAY, KSOPHT0101-Z2100, OVERLAND PARK, KS, 66251-2100, US

(73) Assignee: SPRINT COMMUNICATIONS COMPANY L.P., Overland Park, KS (US)

(21) Appl. No.: 11/562,121

(22) Filed: Nov. 21, 2006

(51) Int. Cl. G06F 15/16

(52) U.S. Cl. 709/230

(57) ABSTRACT

A method, system, and computer-readable media are provided for converting text-based messages to binary messages when communicating a Voice-Over Internet Protocol call. The method is able to convert unique text-based fields into binary representations in a manner that maintains the global uniqueness of the text-based filed while reducing its size. The method includes identifying a text-based field within a text-based protocol message, such that the text-based field is identified as having to be globally unique; compressing the text-based field into a binary representation using a hashing algorithm, wherein the binary representation is globally unique; and transmitting the binary representation of the text-based field to a recipient.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Today, in establishing a Voice-over Internet Protocol (VoIP) call, there are a number of signaling messages exchanged between a user's VoIP communication device and the network facilitating the call. The industry is moving towards a text-based signaling message system called Session Initiation Protocol (SIP). SIP is an application-layer control protocol for creating, modifying, and terminating sessions with one or more participants. These sessions can include Internet telephone calls, multimedia distribution, and multimedia conferences. A problem with SIP is that its text-based messages tend to be large. These large messages tend to take longer to process which in turn increases the time it takes to send the message and establish a VoIP call. Some methods have attempted to solve this problem by compressing the text-based messages in order to effectively reduce them to a binary form in an attempt to reduce the size.

Typically, converting text messages to a binary representation is done using tokens. Certain phrases, words, or values that are commonly used can be assigned binary tokens that can be used to represent the common characters. However, there are some fields within the text message which have to be unique and therefore do not include commonly used characters. A problem with the reduction methods from text to binary is that there is no current way of representing unique fields in a binary format.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present invention is defined by the claims below. Embodiments of the present invention solve at least the above problems by providing a system, method, and computer-readable media for, among other things, converting text-based messages to binary messages when establishing a Voice-over Internet protocol call.

Accordingly, in one aspect, embodiments of the present invention are directed to a method for converting text-based messages to binary messages when communicating a Voice-over Internet Protocol call. The method includes identifying a text-based field within a text-based protocol message. In most cases, the text-based field is identified as having to be globally unique. The method further includes compressing the text-based field into a binary representation using a hashing algorithm, wherein the binary representation is globally unique. Additionally, the method includes transmitting the binary representation of the text-based field to a recipient.

In another aspect of the invention, an embodiment is directed to computer-readable media for performing a method of converting text-based messages to binary messages when communicating a Voice-over Internet Protocol call. The performed method includes generating a Call Identifier. The Call Identifier may include an Internet Protocol address and a timestamp. The performed method further includes compressing the Call Identifier into a binary representation using a hashing algorithm. In most instances the binary representation is globally unique. The method additionally includes transmitting the binary representation to a recipient.

In yet another aspect of the invention, an embodiment is directed to a system for converting text-based messages to binary messages when communicating in a Voice-over Internet Protocol call. The system includes a message generator for generating a text-based field within a text-based protocol message. The system further includes a compression component for compressing the text-based field into a binary representation using a hashing algorithm. In most instances the binary representation is globally unique. Additionally, the system includes a communication interface for transmitting the binary representation of the text-based field to a recipient.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram illustrating an exemplary operating environment for implementing the invention.

FIG. 2 is a block diagram of an exemplary system for implementing the invention.

FIG. 3 is a flow diagram illustrating an exemplary method of converting text-based messages to binary messages when establishing a Voice-over Internet protocol call.

FIG. 4 is another flow diagram illustrating an exemplary method of converting text-based messages to binary messages when establishing a Voice-over Internet protocol call.

### DETAILED DESCRIPTION

Embodiments of the present invention provide systems, methods, and computer-readable media for converting text-based messages to binary messages when communicating a Voice-over Internet Protocol (VoIP) call. The invention obtains the advantage of being able to convert unique text-based fields within such messages into binary representations. These binary representations are generated in a manner that maintains the uniqueness of the original text-based field while compressing the overall size of the unique text-based field. The compressed size of the unique field enables the field to be processed faster which in turn can reduce the time it takes to establish and communicate VoIP calls.

Further, various technical terms are used throughout this description. A definition of such terms can be found in Newton's Telecom Dictionary by H. Newton, 21^{st} Edition (2005). These definitions are intended to provide a clearer understanding of the ideas disclosed herein but are not intended to limit the scope of the present invention. The definitions and terms should be interpreted broadly and liberally to the extent allowed the meaning of the words offered in the above-cited reference.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

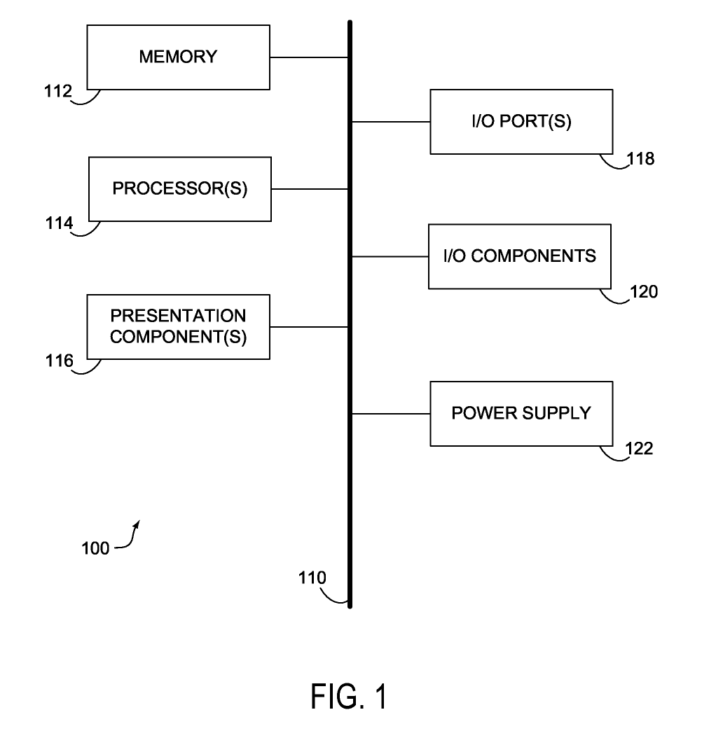

Referring initially to FIG. 1 in particular, an exemplary operating environment for implementing the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

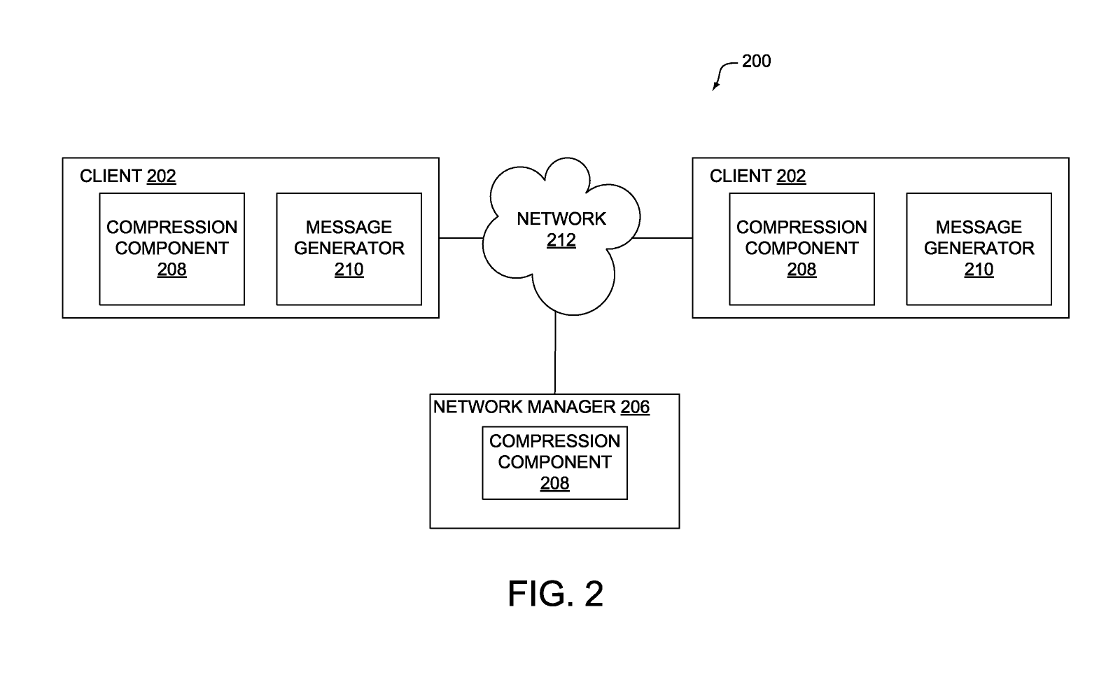

FIG. 2 is a block diagram of an exemplary system for implementing the invention. The system includes a plurality of clients 202, network manager 206, and network 212. In an embodiment, each client 202 and network manager 206 are representations of a computing device 100 as described in FIG. 1. Moreover, client 202 may be or can include a desktop or laptop computer, a network-enabled mobile telephone (with or without media capturing/playback capabilities), a VoIP phone, a wireless email client, other software client, a machine or a device to perform various tasks or to provide various functions including Web browsing, search, and electronic mail (email). Client 202 may additionally be any portable media device such as digital still camera devices, digital video cameras (with or without still image capture functionality), media players such as personal music players and personal video players, and any other portable media device.

Client 202 may also be or can include a server such as a workstation running various operating systems or platforms including Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, or OpenStep™.

Client 202 can include a communication interface. The communication interface may be an interface that can allow the client to be directly connected to any other client or device or allows the client 202 to be connected to a client or device over network 212. Network 212 can include, for example, a local area network (LAN), a wide area network (WAN), or the Internet. In an embodiment, the client 202 can be connected to another device via a wireless interface through a wireless network 212.

In an embodiment, client 202 is a VoIP communication device. In such an embodiment, client 202 can also include a compression component 208 and a message generator 210. The message generator 210 is utilized to generate a plurality of messages that are exchanged between client devices when establishing and maintaining a VoIP call. One such message that can be generated is an invite message. In an embodiment where a Session Initiation Protocol (SIP) is being implemented, the invite message is a SIP Invite message. The invite message is used to establish a VoIP call from a source client device to a destination client device. In an embodiment, the invite message is generated by the source client device that is interested in establishing a VoIP call with the destination client device. The invite message is transmitted by the source client device and is received by the destination client device that the source client device wishes to communicate with. In an embodiment, the invite message may first be transmitted to a network manager 206 before it is sent to the destination client device.

The invite message can include a Call Identifier (Call ID). The Call ID is used to uniquely identify a call between two or more client devices. The Call ID can also be used to enhance seamless mobility of established calls. This may be particularly true in the case when a call moves from one network to another during the call session. An example of this is a mobile user who may have established a call initially in a foreign (or visited) network (Wi-Fi Hotspot for example) and then moves out of coverage of the foreign network into coverage of his home network (CDMA for example). During this transition, the same session may be established in both networks. Ensuring that Call-IDs are globally unique helps ensure that there is no possibility of Call ID “collisions” in either network, that the sessions are easily identified, and that the transitions can be made seamlessly.

In an embodiment, the Call ID is created by concatenating the Internet Protocol (IP) address of the source client device with a timestamp that represents the time the call was initiated. In other embodiments, the Call ID may comprise other parameters in addition to one or more of an IP address and a timestamp. In an embodiment, the IP address is an IP version 6 (IPv6) address. An IPv6 address may generally be 128 bits long. An IPv6 address is typically composed of two logical parts: a 64 bit sub-network prefix and a 64 bit host component. IPv6 addresses are typically written as eight groups of four hexadecimal digits which may also be represented as eight groups of four ASCII characters separated by ASCII colons. In all, the IPv6 address may comprise around 38 bytes or 304 binary bits to store or send. Additionally, the timestamp may comprise a bit stream of 8 ASCII characters used to represent time. The 8 character timestamp concatenated with the IPv6 address can produce a value that may be unique over at least 100 years. In total, the Call ID may comprise around 46 ASCII characters or 368 bits. In other instances, the Call ID may even comprise more than 46 ASCII characters. A communications system may find this size of the Call ID to be too large to store or send. In some instances, such a size of the Call ID may even have a negative impact on performance.

In an embodiment, the Call ID must be generated to be globally unique over space and time since it is used to identify one particular call. Due to their uniqueness, Call IDs are generally non-repetitive and do not have commonly repeating values. As such, it can be difficult and inefficient to compress Call IDs using tokens. As a result, compression techniques of today that attempt to compress the rather large Call ID are inadequate, and in most cases, the Call ID is transmitted in plain text. Again, the plain text version of the Call ID could be between 50-60 ASCII characters in length. A communications system may again find this size of the Call ID to be too large to store or send, and the Call ID may have a negative impact on performance.

Compression component 208 is used to provide an adequate compression technique for compressing Call IDs. The compression component 208 is utilized to provide a compression technique that can make the Call ID more compact in size while maintaining the Call ID's uniqueness over all other Call IDs. In compressing a Call ID, the compression component 208 employs a cryptographic hashing algorithm. One such cryptographic algorithm employed by the compression component 208 is the Message-Digest algorithm 5 (MD5) that can be used to reduce inputted values to a 128-bit value. By inputting a Call ID into the MD5 algorithm, the compression component 208 can reduce the size of the Call ID to a 128 bit value compared to a 350 and above bit value in an uncompressed format. Using the MD5 algorithm also helps ensure that the binary output of the Call ID is unique, as the binary output is unique over 2¹²⁸ values. The uniqueness of a Call ID can further be ensured by either concatenating the IPv6 address and timestamp of the Call ID with a cryptographic Pseudo random Number (PN) of any length, or seeding the MD5 algorithm with the PN. In either case, the MD5 output will still be a 128-bit value. In an embodiment, a cryptographic hashing algorithm, other than the MD5 algorithm, that can produce a 128-bit value from an inputted Call ID may be employed by the compression component 208. In another embodiment, a cryptographic hashing algorithm that can produce a bit value greater than 128 bits may be employed by the compression component 208. For example, the compression component 208 may be configured to use a Secure Hash Algorithm 1 (SHA-1) that can produce a 160-bit value from an inputted Call ID.

Network manager 206 may be or can include a server such as a workstation running various operating systems or platforms including Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, or OpenStep™. Network manager 206 is utilized to manage communication between one or more subscribing client devices 202 on network 212. Network manager 206 can also be utilized to store information regarding client devices 202 such as profile information of subscribing users and client devices 202, call history of client devices 202, and billing information of subscribing users. In an embodiment, network manager 206 can also include a compression component 206 that can be used to compress messages sent by a client 202. For example, in an embodiment, before transmitting a text message to a destination client device, a source client device can first transmit the uncompressed text message to network manager 206 wherein the network manager can compress the text message for the source client device. Once the network manager 206 compresses the text message, the network manager can pass the compressed text message to the destination client device.

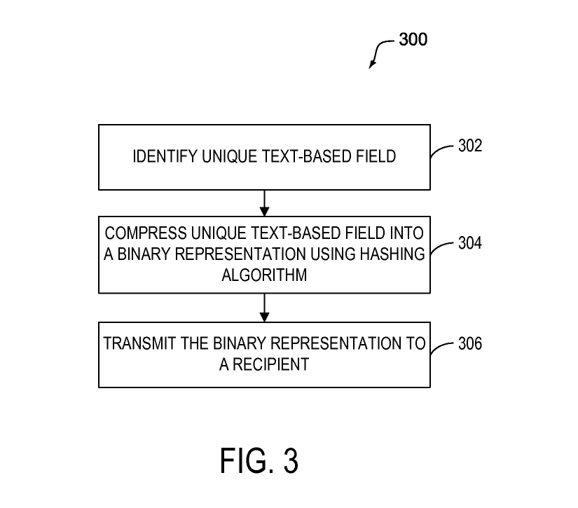

FIG. 3 is a flow diagram illustrating an exemplary method 300 of converting text-based messages to binary messages when establishing a VoIP call. The method of FIG. 3 can be utilized for converting text-based fields that are intended to be unique within messages sent in text-based protocols. In an embodiment, the text-based protocol is a Session Initiation Protocol (SIP). In another embodiment, the text-based protocol may be a Hypertext Transfer Protocol (HTTP). In an embodiment, the method of FIG. 3 is executed within a client device such as client 202. In another embodiment, the method of FIG. 3 is executed within a network manager such as network manager 206.

At operation 302, a text-based field within a text-based protocol message is identified as being globally unique. In an embodiment, such a text-based field is a Call ID. The text-based field may, for example, have a recognizable identifier associated with it that identifies the text-based field as needing to be globally unique. At operation 304, the identified text-based field is compressed into a binary representation using a cryptographic hashing algorithm. The text-based field may be compressed using a compression component, for example, such as compression component 208. In an embodiment, the cryptographic hashing algorithm is a MD5 algorithm. In such an embodiment, the binary representation may be a 128-bit value that helps ensure that the field is globally unique. At operation 306, the binary representation of the text-based field is transmitted to a recipient. The recipient may be, for example, a network manager or a client device.

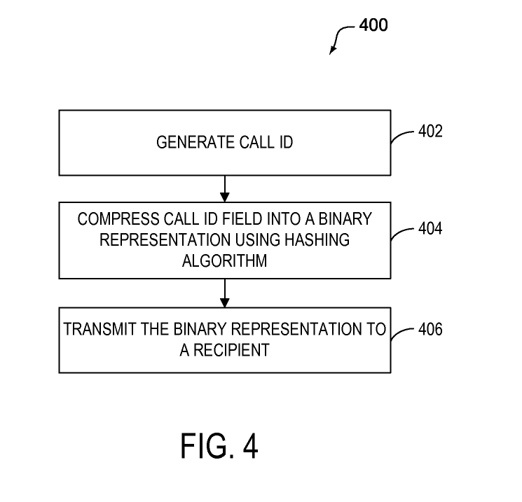

FIG. 4 is another flow diagram illustrating an exemplary method 400 of converting text-based messages to binary messages when establishing a VoIP call. The method of FIG. 4 can be utilized for converting text-based fields that are intended to be unique within messages sent in text-based protocols. In an embodiment, the text-based protocol is a Session Initiation Protocol (SIP). In another embodiment, the text-based protocol may be a Hypertext Transfer Protocol (HTTP). In an embodiment, the method of FIG. 4 is executed within a client device such as client 202.

At operation 402, a Call ID is generated. In an embodiment, the Call ID is a text-based field within a SIP Invite message. The Call ID can include an IP address and a timestamp, wherein the timestamp indicates the time when the VoIP call is being initiated. In other embodiments, the Call ID can include other parameters in addition to the IP address and the timestamp. In an embodiment, the IP address is an IPv6 address. At operation 404, the Call ID is compressed into a binary representation using a cryptographic hashing algorithm. The Call ID may be compressed using a compression component, for example, such as compression component 208. In an embodiment, the cryptographic hashing algorithm is a MD5 algorithm. In such an embodiment, the binary representation may be a 128-bit value that helps ensure that the field is globally unique. At operation 406, the binary representation of the Call ID is transmitted to a recipient. The recipient may be, for example, a network manager or a client device.

In addition to the Call ID, the invention can be utilized for compressing other fields that need to be globally unique. One such field is a branch field within a SIP Via header. The Via header field may be used to indicate the transport used for a session call and can identify a location where a call is to be sent. The Via header field value typically includes a branch parameter. The branch parameter is used to identify the call created by a client device. The branch parameter value must also be unique across space and time for calls initiated by a client device.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method of converting text-based messages to binary messages when communicating a voice over internet protocol call, comprising:
identifying a text-based field within a text-based protocol message, wherein the text-based field is globally unique;
compressing the text-based field into a binary representation using a hashing algorithm, wherein the binary representation is globally unique; and
transmitting the binary representation of the text-based field to a recipient.

2. The method according to claim 1, wherein the text-based field is a call identifier, the call identifier comprising an Internet Protocol address and a timestamp.

3. The method according to claim 2, wherein the Internet Protocol address is an IPv6 address.

4. The method according to claim 1, wherein the text-based protocol is a Session Initiation Protocol.

5. The method according to claim 1, wherein the hashing algorithm is a Message-Digest algorithm 5.

6. The method according to claim 1, wherein the recipient is at least one of a Voice over Internet protocol phone and a network manager.

7. The method according to claim 1, wherein the method is executed within a Voice over Internet protocol phone.

8. One or more tangible computer-readable media having computer-useable instructions embodied thereon for performing a method of converting text-based messages to binary messages when communicating a voice over internet protocol call, the method comprising:
generating a Call Identifier, the Call Identifier including an Internet Protocol address and a timestamp;
compressing the Call Identifier into a binary representation using a hashing algorithm, the binary representation being globally unique; and
transmitting the binary representation to a recipient.

9. The media according to claim 8, wherein the Internet Protocol address is an IPv6 address.

10. The media according to claim 8, wherein the Call Identifier is included within a text-based protocol message.

11. The media according to claim 10, wherein the text-based protocol is a Session Initiation Protocol.

12. The media according to claim 8, wherein the hashing algorithm is a Message-Digest algorithm 5.

13. The media according to claim 8, wherein the method is executed within a Voice over Internet protocol phone.

14. The media according to claim 8, wherein the recipient is at least one of a Voice over Internet protocol phone and a network manager.

15. A system for converting text-based messages to binary messages when communicating a voice over internet protocol call, comprising:
a message generator for generating a text-based field within a text-based protocol message;
a compression component for compressing the text-based field into a binary representation using a hashing algorithm, wherein the binary representation is globally unique; and
a communication interface for transmitting the binary representation of the text-based field to a recipient.

16. The system according to claim 15, wherein the text-based field is a call identifier, the call identifier comprising an Internet Protocol address and a timestamp.

17. The system according to claim 16, wherein the Internet Protocol address is an IPv6 address.

18. The system according to claim 15, wherein the text-based protocol is a Session Initiation Protocol.

19. The system according to claim 15, wherein the hashing algorithm is a Message-Digest algorithm 5.

20. The system according to claim 15, wherein the system is selected from a group including a Voice over Internet protocol phone.
